(19) United States
(12) Patent Application Publication
(10) Pub. No.: US 2020/0014495 A1
(43) Pub. Date: Jan. 9, 2020

(54) METHOD AND APPARATUS FOR CROSS RETRANSMISSION BETWEEN GUL AND SUL

(71) Applicant: Intel IP Corporation, Santa Clara, CA (US)

(72) Inventors: Huaning Niu, San Jose, CA (US); Wenting Chang, Beijing (CN); Qiaoyang Ye, Fremont, CA (US); Seau S. Lim, Swindon (GB); Salvatore Talarico, Sunnyvale, CA (US)

(21) Appl. No.: 16/483,388

(22) PCT Filed: Mar. 9, 2018
(86) PCT No.: PCT/CN2018/078537

§ 371 Date: Aug. 2, 2019

(30) Foreign Application Priority Data
Mar. 9, 2017 (CN) PCT/CN2017/076076

(51) Int. Cl. H04L 1/18; H04L 1/16; H04L 5/00; H04W 72/04

(52) U.S. Cl. CPC H04L 1/1822; H04L 1/1887; H04W 72/042; H04L 1/1614; H04L 5/0055; H04L 1/1812

(57) ABSTRACT

Provided herein are method and apparatus for cross retransmission between Grant-less Uplink transmission (GUL) and Scheduled Uplink transmission (SUL). An embodiment provides an apparatus for a user equipment (UE) comprising baseband circuitry including one or more processors to: encode an uplink (UL) transmission data for transmission to an evolved Node B (eNB) on an un-licensed spectrum; determine a mode of re-transmission for the UL transmission as a scheduled mode in which the re-transmission is based on a re-transmission grant derived from downlink control information (DCI) received from the eNB or a grant-less mode in which the re-transmission is performed without the re-transmission grant from the eNB; and encode the re-transmission of the UL transmission based on the determined mode. Also provided is hybrid automatic repeat request (HARQ) feedback for GUL and SUL. At least some embodiments allow for maximum channel occupancy time (MCOT) sharing.

### CROSS REFERENCES TO RELATED APPLICATIONS

This application claims priority to International Application No. PCT/CN2017/076076 filed on Mar. 9, 2017, entitled “CROSS RETRANSMISSION BETWEEN GRANTLESS UPLINK (GUL) AND SCHEDULED UPLINK (SUL)”, which is incorporated by reference herein in its entirety for all purposes.

### TECHNICAL FIELD

Embodiments of the present disclosure generally relate to apparatuses and methods for wireless communications, and in particular to operation of wireless cellular systems in unlicensed spectrum.

### BACKGROUND ART

Explosive wireless traffic growth has led to an urgent need of rate improvement. With mature physical layer techniques, further improvement in the spectral efficiency may be marginal. On the other hand, the scarcity of licensed spectrum in low frequency band results in a deficit in data rate boost. Thus, there are emerging interests in the operation of wireless cellular systems in unlicensed spectrum.

### SUMMARY

An embodiment of the disclosure provides User Equipment (UE) including circuitry configured to: encode an uplink (UL) transmission data for transmission to a base station (e.g. an evolved Node B (eNB) or a next generation node B (gNB)) on an unlicensed spectrum; determine a mode of re-transmission for the UL transmission as one of: a scheduled mode in which the re-transmission is based on a re-transmission grant derived from downlink control information (DCI) received from the eNB, and a grant-less mode in which the re-transmission is performed without the re-transmission grant from the eNB; and encode the re-transmission of the UL transmission based on the determined mode.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 is a diagram of an example environment in which apparatuses and/or methods described herein may be implemented.

FIG. 2 shows an illustrative scenario that may occur on an unlicensed spectrum in the environment of the disclosure.

FIG. 3 is a flow chart showing operations for Uplink (UL) transmission and re-transmission in accordance with various embodiments of the disclosure.

FIG. 4 shows an example Hybrid Automatic Repeat Request (HARQ) bitmap in accordance with various embodiments of the disclosure.

FIG. 5 shows an example of organization of HARQ domain in accordance with various embodiments of the disclosure.

FIG. 6 is a flow chart showing a method for UL re-transmission in accordance with various embodiments of the disclosure.

FIG. 7 is a flowchart showing a method for UL re-transmission in accordance with various embodiments of the disclosure.

FIG. 8 is a flowchart showing a method for UL re-transmission in accordance with various embodiments of the disclosure.

FIG. 9 illustrates a general block diagram of a wireless communication apparatus in accordance with various embodiments of the disclosure.

### DETAILED DESCRIPTION OF EMBODIMENTS

Various aspects of the illustrative embodiments will be described using terms commonly employed by those skilled in the art to convey the substance of their work to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in an embodiment” is used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

One major enhancement in the 3rd Generation Partnership Project (3GPP) Release 13 has been to enable its operation in the unlicensed spectrum via Licensed-Assisted Access (LAA), which expands the system bandwidth by utilizing the flexible carrier aggregation (CA) framework. Enhanced operation of Long Term Evolution (LTE) systems in unlicensed spectrum is expected in future releases and 5-th generation (5G) systems. Potential LTE operation in unlicensed spectrum includes but is not limited to the LTE operation in the unlicensed spectrum via dual connectivity (DC)—known as DC-based LAA, and the standalone LTE system in the unlicensed spectrum, where LTE-based technology solely operates in unlicensed spectrum without requiring an “anchor” in licensed spectrum, known as MuLTEfire™ (or “MF”). MuLTEfire combines the performance benefits of LTE technology with the simplicity of WiFi-like deployments and is envisioned as a significantly important technology component to meet the ever-increasing wireless traffic. To enable the co-existence of the LTE radio nodes and other unlicensed nodes, a listen-before-talk (LBT) mechanism (also known as Clear Channel Assessment (CCA)) has also been proposed in which the LTE radio node determines whether a particular frequency channel is already occupied (e.g., by a WiFi node) before using the particular frequency channel. That is, with LBT, data may only be transmitted when a channel is sensed to be idle.

In a MuLTEfire system, User Equipment (UE) may perform uplink transmission of data under scheduling from a base station. This manner is referred to as Scheduling-based Uplink transmission (SUL) in the present disclosure. The UL data rate in this manner, however, is limited for two reasons. First the UE has to process the UL grant from the base station, which involves a well-known 4 millisecond (ms) processing delay and limits the available UL frames at given transmission opportunities (TxOPs). Second, “double” LBT operations may be used since the base station may perform LBT before transmitting Physical Downlink Control Channel (PDCCH) and the UE also may perform LBT to acquire the channel for data transmission.

Recently, Grant-less Uplink transmission (GUL) has been proposed to improve the UL data rate, for example in MuLTEfire systems. GUL transmission may be performed using the frame structure of Semi-Persistent Scheduling (SPS) transmission. GUL does not need to wait for the UL grant from the base station and hence mitigates the delay resulted from the two reasons above. GUL allows a MuLTEfire system to have higher probability to acquire the channel since both base station and UE can perform independent LBT. However, GUL is initialized by the UE, and the re-transmission procedure as SPS cannot be reused (e.g. evolved Node B (eNodeB or eNB) or next generation node B (gNB) may not correctly detect the presence of GUL). This presents difficulties in handling re-transmission in case of a failed UL transmission.

The present disclosure provides approaches to perform UL re-transmission on unlicensed spectrum, e.g. in LTE-LAA or MuLTEfire systems. In accordance with some embodiments of the disclosure, a mode for UL re-transmission is determined as a scheduled mode based on a grant from the base station or a grant-less mode without such a grant. A plurality of options are discussed in the present disclosure for making this determination. HARQ mechanism may be used, and HARQ feedback is discussed for GUL and SUL. At least some embodiments of the disclosure allow for Maximum Channel Occupancy Time (MCOT) sharing.

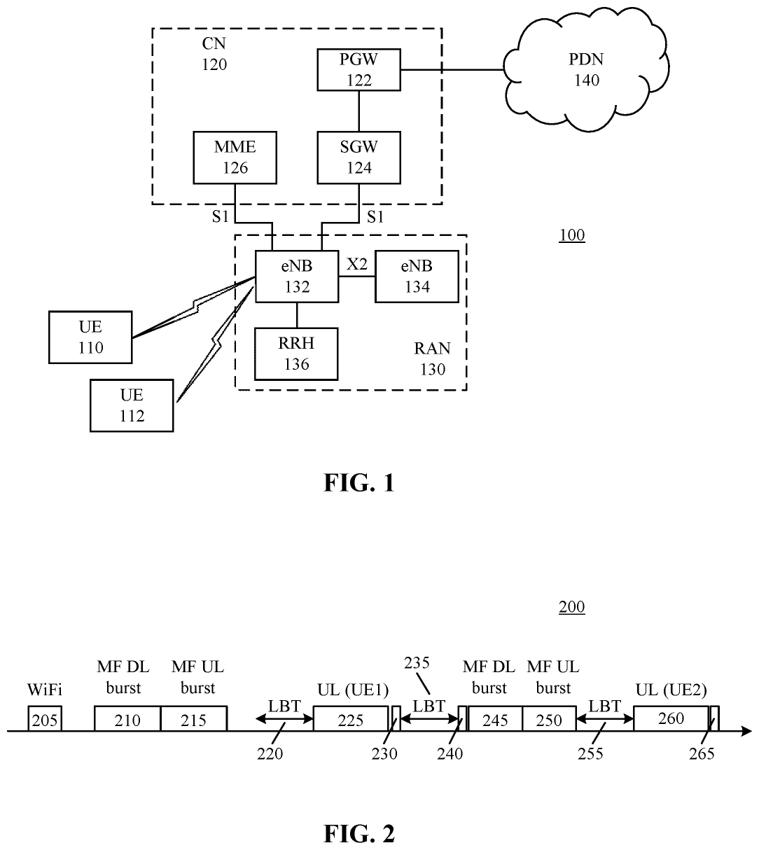

FIG. 1 is a diagram of an example environment in which apparatuses and/or methods described herein may be implemented. As illustrated, in environment 100, a wireless network which may include core network (CN) 120 and radio access network (RAN) 130 may provide network connectivity to User Equipment (UE) 110 and UE 112. The wireless network may provide UEs 110 and 112 with access to one or more external networks, such as packet data network (PDN) 140. RAN 130 may be a 3GPP-based radio access network, e.g. an Evolved Universal Mobile Telecommunications System (UMTS) Terrestrial Radio Access (E-UTRA) based radio access network or another type of radio access network. RAN 130 may be associated with a network operator that controls or otherwise manages CN 120. CN 120 may include an Internet Protocol (IP)-based network.

UE 110 may include a portable computing and/or communication device, including but not limited to, a cellular phone, a laptop computer with connectivity to a cellular wireless network, a tablet device, a personal digital assistant (PDA), a gaming console, and the like. UE 110 may also include non-portable computing devices, e.g. a desktop computer, consumer or business appliances, or another device having an ability to be wirelessly connected to RAN 130. In the following description, embodiments of the disclosure will be described in such context that UE 110 is a cellular phone. UE 112 may be a device same as or similar to UE 110.

In the context of the present disclosure, UE 110 may operate using unlicensed spectrum, e.g. via LTE-LAA or MuLTEfire. For instance, UE 110 may include radio circuitry capable of receiving a first carrier using licensed spectrum and a second carrier using unlicensed spectrum simultaneously or alternately. The second carrier may be, for example, a 5 GHz spectrum used by WiFi devices. Further, although FIG. 1 shows two UEs 110 and 112 for simplicity, in practice there may be one or more UEs operate in environment 100. The UEs additional to UE 110 and 112 may be legacy UEs that can operate only on licensed spectrum, or UEs that are capable of utilizing the unlicensed spectrum.

RAN 130 may be a 3GPP access network that includes one or more radio access technologies (RATs). RAN 130 may include one or more base stations, for example eNB 132 and eNB 134. eNBs 132 and 134 may include eNBs that provide coverage to a relatively large (macro cell) area or a relatively small (small cell) area. Small cells may be deployed to increase system capacity by including a coverage area within a macro cell. Small cells may include picocells, femtocells, and/or home NodeBs. Small cells may, in some situations, be operated as Secondary Cells (SCells), in which the macro cell (known as the Primary Cell (PCell)) may be used to exchange important control information and provide robust data coverage and the SCell may be used as a secondary communication channel, such as to offload downlink data transmissions. The eNBs may include one or more Remote Radio Heads (RRH), such as RRH 136. RRH 136 can extend the coverage of an eNB by distributing the antenna system of the eNB. RRH 136 may be connected to eNB 132 by optical fiber (or by another low-latency connection). The base stations may each include circuitry to implement the operations discussed herein.

In the context of the present disclosure, the base stations may operate using unlicensed spectrum, e.g. via LTE-LAA or MuLTEfire. For instance, eNB 132 may include radio circuitry capable of transmitting and receiving both the first carrier using licensed spectrum and the second carrier using unlicensed spectrum.

Core network 120 may include an IP-based network. In the 3GPP network architecture, CN 120 may include an Evolved Packet Core (EPC). As illustrated, core network 120 may include Packet Data Network Gateway (PGW) 122, Serving Gateway (SGW) 124, and Mobility Management Entity (MME) 126. Although certain network devices are illustrated in environment 100 as being part of RAN 130 and core network 120, whether a network device is labeled as being in the “RAN” or the “core network” of environment 100 may be an arbitrary decision that may not affect the operation of wireless network.

PGW 122 may include one or more devices that act as the point of interconnect between core network 120 and external IP networks, such as PDN 140, and/or operator IP services. PGW 122 may route packets to RAN 130 from the external IP networks, or from RAN 130 to the external IP networks. SGW 124 may include one or more network devices that aggregate traffic received from eNBs 132 and/or 134. SGW 124 may generally handle user plane traffic. MME 126 may include one or more computation and communication devices that perform operations to register UE 110 or 112 with core network 120, establish bearer channels associated with a session with UE 110 or 112, hand off UE 110 or 112 from one eNB 132 to another, and/or perform other operations. MME 126 may generally handle control plane traffic.

PDN 140 may include one or more packet-based networks. PDN 140 may include one or more external networks, such as a public network (e.g., the Internet) or proprietary networks that provide services that are provided by the operator of core network 120 (e.g., IP multimedia (IMS)-based services, transparent end-to-end packet-switched streaming services (PSSs), or other services).

A number of interfaces are illustrated in FIG. 1. An interface may refer to a physical or logical connection between devices in environment 100. The illustrated interfaces may be 3GPP standardized interfaces. For example, as illustrated, eNB 132 may communicate with SGW 124 and MME 126 using the S1 interface (e.g., as defined by the 3GPP standards). eNB 132 and eNB 134 may communicate with one another via the X2 interface. These interfaces are known to those skilled in the art and will not be described in detail.

The quantity of devices and/or networks illustrated in FIG. 1 is provided for explanatory purposes only. In practice, there may be additional devices and/or networks, fewer devices and/or networks, different devices and/or networks, or differently arranged devices and/or networks than illustrated in FIG. 1. Alternatively or additionally, one or more of the devices of environment 100 may perform one or more functions described as being performed by another one or more of the devices of environment 100. Furthermore, while “direct” connections are shown in FIG. 1, these connections should be interpreted as logical communication pathways, and in practice, one or more intervening devices (e.g., routers, gateways, modems, switches, hubs, etc.) may be present.

FIG. 2 shows an illustrative scenario 200 that may occur on an unlicensed spectrum in environment 100 of the present disclosure. The unlicensed spectrum may be a 5 GHz frequency band for a WiFi transmission, for example. As shown in FIG. 2, transmissions of various information may occur including WiFi transmission illustrated at 205, MuLTEfire (MF) downlink bursts illustrated at 210 and 245, MF uplink bursts illustrated at 215 and 250, autonomous UL transmissions 225 and 260 which may be Physical Uplink Shared Channel (PUSCH) or UL control information from UEs (e.g. UEs 110 and 112), and DL control information 230, 240 and 265 for the autonomous UL transmissions. In an embodiment, DL control information 230, 240 and 265 may include acknowledgement (ACK) or negative acknowledgement (NACK) for the UL transmissions and UL Channel State Information (CSI). FIG. 2 also illustrates LBT operations 220, 235 and 255 performed prior to UL or DL transmissions. In an embodiment, LBT operations 220, 235 and 255 each may be category 4 of the LBT (Cat. 4 LBT), as provided in “3rd Generation Partnership Project; Technical Specification Group Radio Access Network; Study on Licensed-Assisted Access to Unlicensed Spectrum; (Release 13)” (3GPP TR 36.889 V13.0.0 (2015-06)).

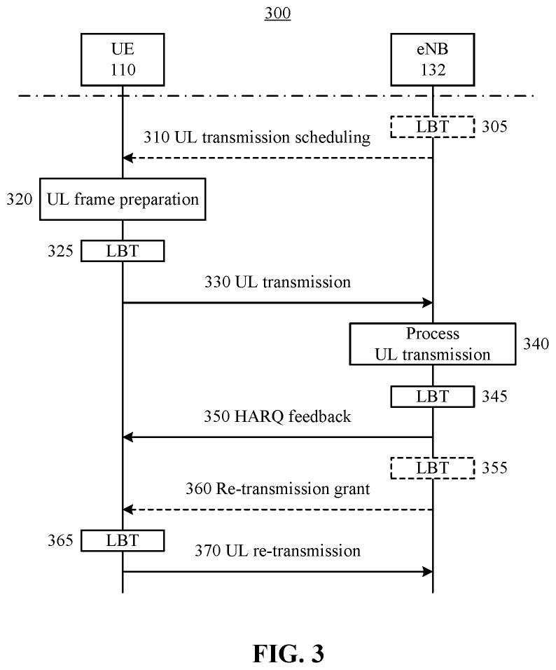

FIG. 3 is a flow chart 300 showing operations for UL transmission and re-transmission in accordance with various embodiments of the disclosure. The operations of FIG. 3 may be used for UE (e.g. UE 110) to transmit user plane or control plane data to a base station (e.g. eNB 132), and may occur on unlicensed spectrum, e.g. in an LTE-LAA or MuLTEfire system. At 305, eNB 132 may perform LBT to sense if a desired channel is idle. As described above, the LBT may be a Cat. 4 LBT. eNB 132 may process (e.g. modulate, encode, etc.) Downlink Control Information (DCI) and transmit the DCI to UE 110 on PDCCH at 310 if the channel is sensed idle. The DCI may include information for scheduling a UL transmission to be performed by UE 110. UE 110 may receive and process (e.g. demodulate, decode, detect, etc.) the DCI, and prepare a UL frame in accordance with the scheduling of eNB 132 at 320. Subsequently or simultaneously, UE 110 may perform LBT at 325, which may also be a Cat. 4 LBT, to sense the availability of the channel. If the channel is sensed idle, UE 110 may process (e.g. modulate, encode, etc.) and transmit the UL transmission data to eNB 132 at 330, for example on PUSCH. The UL transmission may be associated with a HARQ process number. Throughout the disclosure, transmission data or re-transmission data is sometimes referred to as transmission or re-transmission for ease of description.

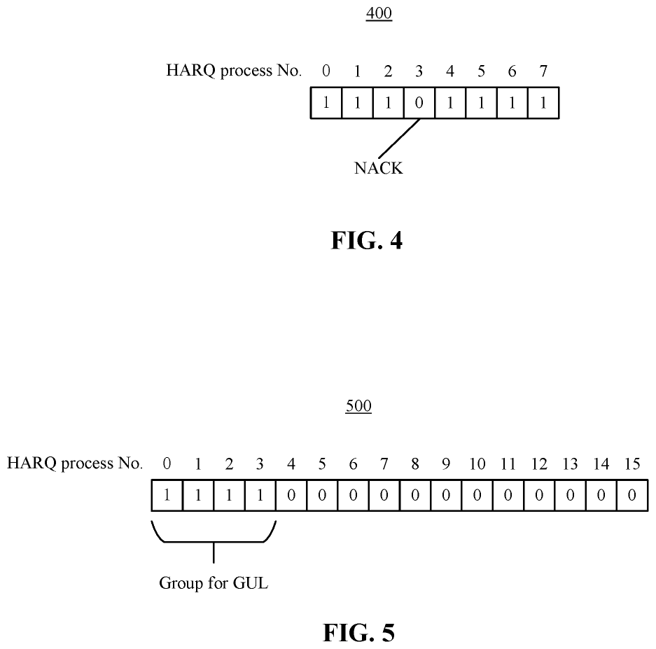

At 340, eNB 132 may receive and process (e.g. demodulate, decode, detect, etc.) the UL transmission that UE 110 transmitted at 330, to extract data or control information therefrom. In accordance with various embodiments of the disclosure, eNB 132 may provide a feedback (e.g. modulate, encode, format, etc. feedback data for transmission) to UE 110 indicating whether the UL transmission has been successfully received and/or demodulated. UE 110 may process (e.g. demodulate, decode, detect, etc.) the feedback to derive the feedback data. In an embodiment, the feedback may be a HARQ feedback, which may be included in PDCCH encoded by eNB 132. For example, eNB 132 may, after performing an LBT operation at 345, send to UE 110 a HARQ bitmap at 350. The HARQ bitmap may include a plurality of bits indicating ACK and NACK at eNB 132 for the UL transmissions associated with corresponding HARQ process numbers. FIG. 4 shows an example HARQ bitmap 400 including 8 bits, each for one HARQ process number. In the example of FIG. 4, bit “1” stands for ACK, indicating that the UL transmission associated with that bit has been successfully demodulated, while bit “0” stands for NACK, indicating a failure of demodulating the associated UL transmission. As shown in FIG. 4, the bit corresponding to HARQ process number 3 is “0”, indicating that eNB 132 fails to demodulate the UL transmission associated with this HARQ process number. The bits corresponding to HARQ process numbers 0-2 and 4-7 are “1”, indicating ACK at eNB 132 for the corresponding HARQ processes, and UE 110 may process and transmit subsequent UL transmissions instead of a re-transmission.

In another embodiment, eNB 132 does not need to send an explicit ACK feedback to UE 110 in case of a successful receipt and demodulation of the UL transmission; rather, eNB 132 may process and send DCI to UE 110, which includes a New Transmission ID (NDI) to schedule a next UL transmission. The NDI may be a bit (0 or 1), and whether the transmission corresponding to the NDI is successful may be indicated by whether the bit is toggled (i.e. changed from 0 to 1 or from 1 to 0). In an embodiment, eNB 132 may each time send a plurality of DCIs (e.g. 8 DCIs) corresponding to a plurality of UL transmissions to UE 110.

If a NACK feedback is sent, i.e. eNB 132 fails to demodulate the UL transmission, UE 110 may need to re-transmit the UL transmission. In accordance with various embodiments of the disclosure, UE 110 may determine a mode of re-transmission for the UL transmission as a scheduled mode (or “SUL re-transmission”) or a grant-less mode (or “GUL re-transmission”), and process (e.g. modulate, encode, etc.) the re-transmission of the UL transmission based on the determined mode. In the scheduled mode, the re-transmission is based on a re-transmission grant derived from DCI received from eNB 132, while in the grant-less mode, the re-transmission is performed without the re-transmission grant from eNB 132. FIG. 3 generally shows that eNB 132 optionally sends the re-transmission grant at 360 to UE 110 after an LBT operation 355, and that UE 110 transmits the UL re-transmission at 370 to eNB 132 after an LBT operation 365. The UL re-transmission at 370 is an SUL re-transmission if it is performed based on the re-transmission grant at 360, and a GUL re-transmission if the re-transmission grant at 360 is absent (e.g. the re-transmission is performed with an explicit HARQ bitmap in DCI received from eNB 132). The detailed process of determining the mode of re-transmission and performing the re-transmission will be described later.

In the above description with reference to FIG. 3, UL transmission at 330 is performed in the SUL manner since it follows the scheduling from eNB 132 (sent at 310). However, FIG. 3 may also depicts UL transmission in the GUL manner. For GUL transmission, the operations 305 and 310 are eliminated, and UE 110 performs the UL transmission at 330 autonomously without the grant from eNB 132. The operations of UE 110 or eNB 132 in FIG. 3 may be performed, for example, by baseband circuitry of UE 110 or baseband circuitry of eNB 132 as described later.

In some embodiments of the disclosure, UE 110 may determine the mode of re-transmission as the scheduled mode if a HARQ process number associated with the UL transmission falls outside of a predefined group. In the embodiments, the domain of HARQ process numbers may be organized such that only some of them are available for GUL re-transmission. FIG. 5 shows an example of organization 500 of HARQ domain in accordance with various embodiments of the disclosure. In the example of FIG. 5, a group of HARQ process numbers 0, 1, 2 and 3 each have a different configuration from the other HARQ process numbers (e.g. configured with a bit “1” in contrast to “0” for the others) so that the UL transmissions associated with these HARQ process numbers, if need to be re-transmitted (e.g. as indicated in the HARQ bitmap or by the NDI), may be re-transmitted in the grant-less mode. In an embodiment, the fact that a HARQ process number falls within the group does not imply that a UL transmission associated therewith is necessarily to be re-transmitted in the grant-less mode; rather, UE 110 may determine the mode of re-transmission as the grant-less mode or the scheduled mode depending on other factors (e.g. in combination with the determinations described later). On the other hand, if a UL transmission associated with a HARQ process number outside the group (e.g. No. 7 in the example of FIG. 5) needs to be re-transmitted, UE 110 will determine that it cannot be re-transmitted in the grant-less mode and the mode of re-transmission shall be the scheduled mode.

The manner of organizing the domain of HARQ process numbers (i.e. which HARQ process numbers should be put in the group and which not) may depend on the implementation of the base station and is not limited herein. In some embodiments, the group is configured by the base station through dedicated or broadcast Radio Resource Control (RRC) signaling, which UE may receive and decode (e.g. demodulate, decode, detect, etc.). For example, eNB 132 may send to UE 110 an RRC message, in which configuration data such as a sequence of bits “1111000000000000” is encoded, to configure UE 110 with the group of HARQ process numbers as shown in FIG. 5. When a UL transmission is indicated as NACK (e.g. in the HARQ bitmap or by the NDI), if the HARQ process number associated therewith does not fall within the group of {0, 1, 2, 3}, UE 110 will determine the mode of re-transmission as the scheduled mode; otherwise the mode of re-transmission can be determined as the grant-less mode, optionally taking other factors into consideration.

Though in FIG. 5, a bit “1” is used to indicate the members of the group of HARQ process numbers associated with GUL re-transmission and “0” is used for the others, this is merely an example. It is also possible that a bit “0” is used to indicate the members of the group of HARQ process numbers associated with GUL re-transmission while “1” for the others. Though 16 HARQ process numbers are configured in the example of FIG. 5, it is merely illustrative. Any number greater than 1 (e.g. 4, 8, 15, etc.) may be applied instead of 16. Though 4 HARQ process numbers are put in the group, it is also illustrative and the quantity may be changed to other practical number, e.g. 1, 2 and the like. The numbers in the group are not necessarily consecutive. For example, the group may be configured to include HARQ process numbers 1, 2, 6, or numbers 1, 3, 5.

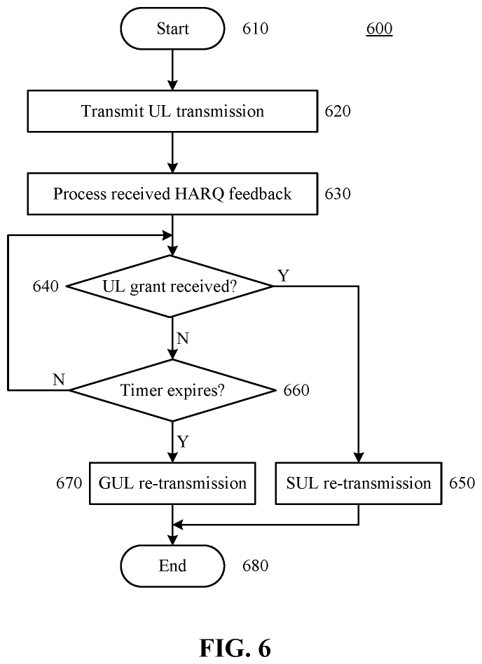

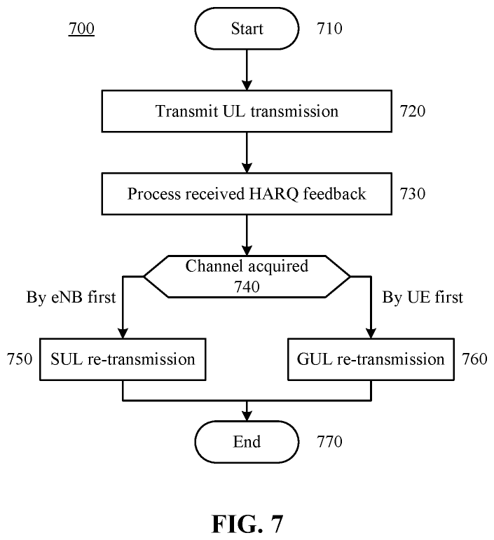

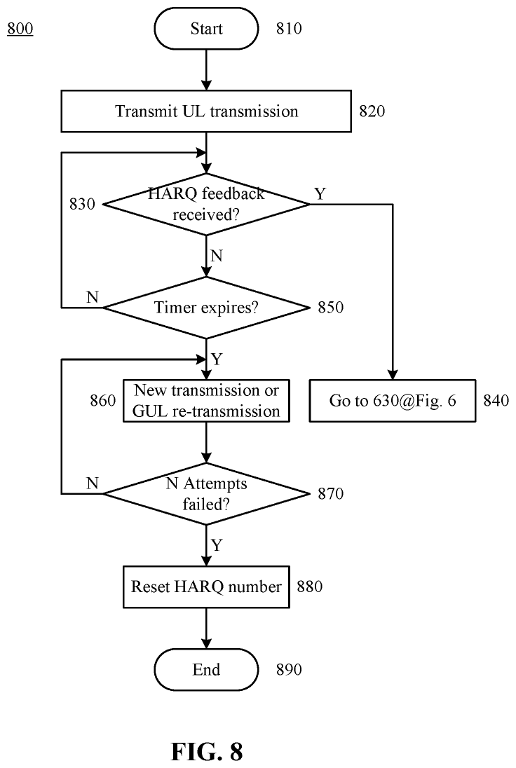

In some embodiments, SUL re-transmission may be provided with a higher priority than GUL re-transmission. FIG. 6 is a flow chart 600 showing a method for UL re-transmission in accordance with the embodiments of the disclosure. Again, the operations of FIG. 6 may be used for UE (e.g. UE 110) to transmit user plane or control plane data to a base station (e.g. eNB 132), and may occur on unlicensed spectrum, e.g. in an LTE-LAA or MuLTEfire system. The method starts at 610. At 620, UE 110 may transmit a UL transmission to eNB 132 on an idle channel, similar to the UL transmission at 330 of FIG. 3. In an embodiment, the UL transmission is a GUL transmission. At 630, UE 110 may receive and process a HARQ feedback from eNB 132 to determine whether the UL transmission has been successfully received and/or demodulated. The HARQ feedback may be, for example, a HARQ bitmap as discussed hereinbefore.

For the HARQ process numbers indicated as ACK in the HARQ feedback, UE 110 may continue to perform GUL transmissions for subsequent data or control information. In contrast, for the HARQ process numbers indicated as NACK, eNB 132 may, when it has access to the channel (e.g. after completing an LBT operation), transmit DCI to UE 110 as a UL grant to schedule a re-transmission. The DCI may be configured to assign a whole system bandwidth to UE 110 for re-transmission, or assign one of a plurality of orthogonal resources to one of a plurality of users to enable multiplexing.

Turning back to FIG. 6. UE 110 may maintain one or more timer for the re-transmission. As an example, UE 110 may start a timer upon finishing the UL transmission at 620, or upon receiving the HARQ feedback at 630. UE 110 may determine at 640 if the DCI has been received and the UL grant has been derived within a certain period indicated by the timer. If so, UE 110 may determine the mode of re-transmission as the scheduled mode at 650 and perform the re-transmission in accordance with scheduling from eNB 132. On the other hand, when the timer expires at 660 without receiving the UL grant, UE 110 may determine the mode of re-transmission as the grant-less mode at 670 and perform the re-transmission autonomously. The method ends at 680.

With the process described above, re-transmission may be triggered by the timer. In other words, UE may wait for a certain period, which is determined by the timer, to receive grant from eNB 132 for an SUL re-transmission. However, if no grant has been received when the timer expires, UE 110 will perform a GUL re-transmission. The period for the timer may be configured by eNB 132, or may be a predefined value. The method illustrated in FIG. 6 allows SUL re-transmission, which is centrally controlled by eNB and has high reliability, to have a higher priority than GUL re-transmission.

In an embodiment, UE 110 may maintain a single timer for the re-transmission, and the timer may be shared by a plurality of HARQ processes on UE 110. The timer may be reset each time UE 110 has new data for GUL transmission, or may be reset only when all Transmission Blocks (TBs) are new transmissions. In another embodiment, UE 110 may maintain one or more timers each associated with a single HARQ process. Each of the timers may be set when the associated HARQ process corresponds to a new initial transmission.

In an embodiment, UE 110 may maintain a timer for the HARQ feedback. For example, UE 110 may start the timer upon finishing the UL transmission at 620, and if no HARQ feedback has been received from eNB 132 when the timer expires, UE 110 may determine the mode of re-transmission as the grant-less mode. The re-transmission may be performed for all the HARQ processes for which no HARQ feedback has been received. Otherwise the embodiment may be identical to those described above with reference to FIG. 6.

Comparing FIG. 6 against FIG. 3, it can be found that the LBT operations before transmission and re-transmission have been omitted. The LBT operations do exist in the practical process but are omitted in the drawing for simplicity. This applies also for the processes shown in the later drawings. Nevertheless, one or more LBT operations can be removed from the practical process, resulting in a reduced processing delay. For example, in FIG. 3, eNB 132 performs LBT at 345 before transmitting the HARQ feedback at 350. In an embodiment, eNB 132 may transmit the HARQ feedback in a shared MCOT of another UE, eliminating or shortening the LBT at 345. For example, another UE (e.g. UE 112) may perform a Cat. 4 LBT to sense an idle channel and then transmit a PUSCH within its MCOT, while eNB 132 may utilize this MCOT to transmit the HARQ feedback to UE 110. If the eNB determines that it will take a short period less than a predetermined first threshold (e.g. 16 ms) to transmit the HARQ feedback, the LBT may be eliminated. If it will take a medium period more than the first threshold but still less than a predetermined second threshold (e.g. 25 ms), eNB 132 may perform a short type LBT instead of the Cat. 4 LBT. However, if it will take a period more than the second threshold, eNB may perform the Cat. 4 LBT normally.

Though in the above discussion on MCOT sharing, the HARQ feedback is taken as the example, it should not be taken in a limiting sense; eNB 132 may perform transmission of other information (e.g. DCI, for scheduling DL or UL transmission or re-transmission) to UE 110 in the MCOT of UE 112, without the LBT or with a shorter LBT. Further, the concept of MCOT sharing is not limited to the process of FIG. 6, but may be applied in other processes described herein. MCOT sharing allows for a reduced latency and enables UE to prepare the next transmission in advance.

In some embodiments, the re-transmission may be made opportunistic. FIG. 7 is a flow chart 700 showing a method for UL re-transmission in accordance with the embodiments of the disclosure. The method of FIG. 7 may be used for UE (e.g. UE 110) to transmit user plane or control plane data to a base station (e.g. eNB 132), and may occur on unlicensed spectrum, e.g. in an LTE-LAA or MuLTEfire system. The method starts at 710. UE 110 may transmit a UL transmission, either GUL or SUL, to eNB 132 at 720, and may receive and process a HARQ feedback from eNB 132 at 730 to determine whether the UL transmission has been successfully received and/or demodulated. The operations at 720 and 730 may be similar or identical to the operations at 620 and 630 in FIG. 6, respectively. For example, UE 110 may transmit UL transmissions associated with HARQ process numbers 0 and 1 in SUL manner and UL transmissions associated with HARQ process numbers 2, 3, 4 and 5 in GUL manner at 720, and then receive a HARQ feedback at 730 indicating NACK for the HARQ process number 1 as well as ACK for the other HARQ process numbers.

At 740, a determination is made as to which of eNB 132 and UE 110 acquires an idle channel first. If eNB 132 acquires the channel first, i.e. earlier than UE 110, the mode of re-transmission may be determined as the scheduled mode at 750. However, if UE 110 acquires the channel earlier than eNB 132, UE 110 may determine the mode of re-transmission as the grant-less mode at 760. For the example mentioned above, if eNB 132 acquires the channel first, it may transmit DCI to UE 110 to schedule a re-transmission for HARQ process number 1; whereas if UE 110 acquires the channel first, it may perform a GUL re-transmission without waiting for the grant from eNB 132. In this way, regardless of the modality of transmission (GUL or SUL), once the HARQ feedback is received, UE will perform a re-transmission in the modality that ensures the lowest latency. Method 700 ends at 770.

In some embodiments, UE may maintain a timer to address the re-transmission of GUL. FIG. 8 is a flowchart 800 showing a method for UL re-transmission in accordance with the embodiments of the disclosure. The method starts at 810. UE 110 may transmit at 820 a UL transmission to eNB 132 on an idle channel. The UL transmission may be a GUL transmission. UE 110 may start a timer upon finishing the UL transmission, and determine whether a HARQ feedback for the UL transmission has been received from eNB 132 at 830 while the timer counts down. If UE 110 receives the HARQ feedback before the expiration of the timer, at 840 UE 110 may process the HARQ feedback and, if needed, perform re-transmission, as illustrated in FIG. 6 above. However, if UE 110 determines that no HARQ feedback has been received when the timer expires at 850, UE 110 may interpret this as eNB 132 has not detected the GUL transmission, and may reset the corresponding HARQ process numbers instead of keep waiting. Therefore, at 860 UE 110 may transmit a packet same as the UL transmission at 820, but as a new transmission, since eNB 132 did not detect the previous UL transmission. Alternatively, UE 110 may perform a re-transmission for the UL transmission at 860, e.g. as a GUL re-transmission.

The new transmission or re-transmission at 860 may not necessarily be successfully received at eNB 132. In further embodiments, UE 110 may make a predetermined number (N) of attempts of the new transmission or the re-transmission. If it is determined at 870 that the outcome is the same (e.g. no HARQ feedback is timely received) after these attempts, UE 110 may reset at 880 the HARQ process number associated with the UL transmission, e.g. by HARQ refreshing. The method ends at 890.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

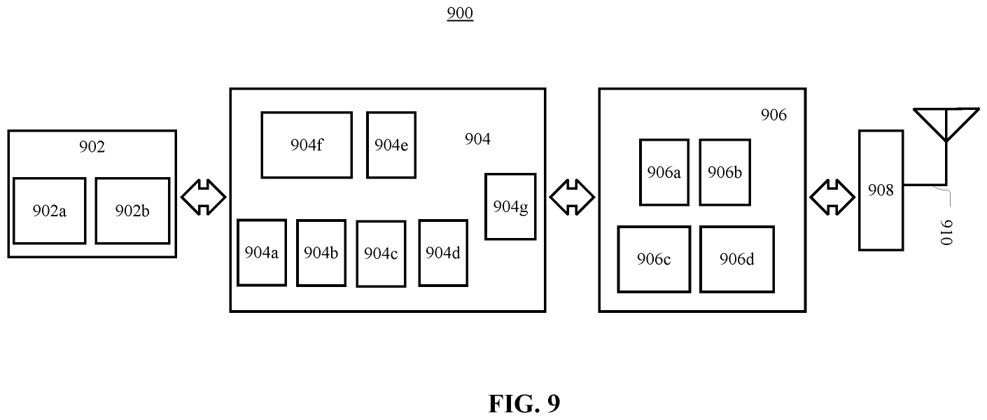

Embodiments described herein may be implemented into an apparatus using any suitably configured hardware and/or software. FIG. 9 illustrates a general block diagram of a wireless communication apparatus 900 in accordance with various embodiments of the disclosure. In embodiments, the apparatus 900 may be, implement, be incorporated into, or otherwise be a part of a user equipment (UE), an evolved NodeB (eNB), and/or some other electronic device. In some embodiments, the apparatus 900 may include application circuitry 902, baseband circuitry 904, Radio Frequency (RF) circuitry 906, front-end module (FEM) circuitry 908 and one or more antennas 910, coupled together at least as shown. In embodiments where the apparatus 900 is implemented in or by an eNB, the apparatus 900 may also include network interface circuitry (not shown) for communicating over a wired interface (for example, an X2 interface, an S1 interface, and the like).

The application circuitry 902 may include one or more application processors. For example, the application circuitry 902 may include circuitry such as, but not limited to, one or more single-core or multi-core processors 902a. The processor(s) 902a may include any combination of general-purpose processors and dedicated processors (e.g., graphics processors, application processors, etc.). The processors 902a may be coupled with and/or may include computer-readable media 902b (also referred to as “CRM 902b”, “memory 902b”, “storage 902b”, or “memory/storage 902b”) and may be configured to execute instructions stored in the CRM 902b to enable various applications and/or operating systems to run on the system.

The baseband circuitry 904 may include circuitry such as, but not limited to, one or more single-core or multi-core processors. The baseband circuitry 904 may include one or more baseband processors and/or control logic to process baseband signals received from a receive signal path of the RF circuitry 906 and to generate baseband signals for a transmit signal path of the RF circuitry 906. Baseband circuity 904 may interface with the application circuitry 902 for generation and processing of the baseband signals and for controlling operations of the RF circuitry 906. For example, in some embodiments, the baseband circuitry 904 may include a second generation (2G) baseband processor 904a, third generation (3G) baseband processor 904b, fourth generation (4G) baseband processor 904c, and/or other baseband processor(s) 904d for other existing generations, generations in development or to be developed in the future (e.g., fifth generation (5G), 6G, etc.). The baseband circuitry 904 (e.g., one or more of baseband processors 904a-d) may handle various radio control functions that enable communication with one or more radio networks via the RF circuitry 906. The radio control functions may include, but are not limited to, signal modulation/demodulation, encoding/decoding, radio frequency shifting, and the like. In some embodiments, modulation/demodulation circuitry of the baseband circuitry 904 may include Fast-Fourier Transform (FFT), precoding, and/or constellation mapping/demapping functionality. In some embodiments, encoding/decoding circuitry of the baseband circuitry 904 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include elements of a protocol stack such as, for example, elements of an evolved universal terrestrial radio access network (E-UTRAN) protocol including, for example, physical (PHY), media access control (MAC), radio link control (RLC), packet data convergence protocol (PDCP), and/or radio resource control (RRC) elements. A central processing unit (CPU) 904e of the baseband circuitry 904 may be configured to run elements of the protocol stack for signaling of the PHY, MAC, RLC, PDCP and/or RRC layers. In some embodiments, the baseband circuitry may include one or more audio digital signal processor(s) (DSP) 904f. The audio DSP(s) 904f may include elements for compression/decompression and echo cancellation and may include other suitable processing elements in other embodiments. The baseband circuitry 904 may further include computer-readable media 904g (also referred to as “CRM 904g”, “memory 904g”, “storage 904g”, or “CRM 904g”). The CRM 904g may be used to load and store data and/or instructions for operations performed by the processors of the baseband circuitry 904. CRM 904g for one embodiment may include any combination of suitable volatile memory and/or non-volatile memory. The CRM 904g may include any combination of various levels of memory/storage including, but not limited to, read-only memory (ROM) having embedded software instructions (e.g., firmware), random access memory (e.g., dynamic random access memory (DRAM)), cache, buffers, etc.). The CRM 904g may be shared among the various processors or dedicated to particular processors. Components of the baseband circuitry 904 may be suitably combined in a single chip, a single chipset, or disposed on a same circuit board in some embodiments. In some embodiments, some or all of the constituent components of the baseband circuitry 904 and the application circuitry 902 may be implemented together, such as, for example, on a system on a chip (SOC).

In some embodiments, the baseband circuitry 904 may provide for communication compatible with one or more radio technologies. For example, in some embodiments, the baseband circuitry 904 may support communication with an E-UTRAN and/or other wireless metropolitan area networks (WMAN), a wireless local area network (WLAN), a wireless personal area network (WPAN). Embodiments in which the baseband circuitry 904 is configured to support radio communications of more than one wireless protocol may be referred to as multi-mode baseband circuitry.

RF circuitry 906 may enable communication with wireless networks using modulated electromagnetic radiation through a non-solid medium. In various embodiments, the RF circuitry 906 may include switches, filters, amplifiers, etc., to facilitate the communication with the wireless network. RF circuitry 906 may include a receive signal path that may include circuitry to down-convert RF signals received from the FEM circuitry 908 and provide baseband signals to the baseband circuitry 904. RF circuitry 906 may also include a transmit signal path that may include circuitry to up-convert baseband signals provided by the baseband circuitry 904 and provide RF output signals to the FEM circuitry 908 for transmission.

In some embodiments, the RF circuitry 906 may include a receive signal path and a transmit signal path. The receive signal path of the RF circuitry 906 may include mixer circuitry 906a, amplifier circuitry 906b and filter circuitry 906c. The transmit signal path of the RF circuitry 906 may include filter circuitry 906c and mixer circuitry 906a. RF circuitry 906 may also include synthesizer circuitry 906d for synthesizing a frequency for use by the mixer circuitry 906a of the receive signal path and the transmit signal path. In some embodiments, the mixer circuitry 906a of the receive signal path may be configured to down-convert RF signals received from the FEM circuitry 908 based on the synthesized frequency provided by synthesizer circuitry 906d. The amplifier circuitry 906b may be configured to amplify the down-converted signals and the filter circuitry 906c may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, mixer circuitry 906a of the receive signal path may comprise passive mixers, although the scope of the embodiments is not limited in this respect.

In some embodiments, the mixer circuitry 906a of the transmit signal path may be configured to up-convert input baseband signals based on the synthesized frequency provided by the synthesizer circuitry 906d to generate RF output signals for the FEM circuitry 908. The baseband signals may be provided by the baseband circuitry 904 and may be filtered by filter circuitry 906c. The filter circuitry 906c may include a low-pass filter (LPF), although the scope of the embodiments is not limited in this respect.

In some embodiments, the mixer circuitry 906a of the receive signal path and the mixer circuitry 906a of the transmit signal path may include two or more mixers and may be arranged for quadrature downconversion and/or upconversion, respectively. In some embodiments, the mixer circuitry 906a of the receive signal path and the mixer circuitry 906a of the transmit signal path may include two or more mixers and may be arranged for image rejection (e.g., Hartley image rejection). In some embodiments, the mixer circuitry 906a of the receive signal path and the mixer circuitry 906a of the transmit signal path may be arranged for direct downconversion and/or direct upconversion, respectively. In some embodiments, the mixer circuitry 906a of the receive signal path and the mixer circuitry 906a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 906 may include analog-to-digital converter (ADC) and digital-to-analog converter (DAC) circuitry and the baseband circuitry 904 may include a digital baseband interface to communicate with the RF circuitry 906.

In some dual-mode embodiments, a separate radio IC circuitry may be provided for processing signals for each spectrum, although the scope of the embodiments is not limited in this respect.

In some embodiments, the synthesizer circuitry 906d may be a fractional-N synthesizer or a fractional N/N+1 synthesizer, although the scope of the embodiments is not limited in this respect, as other types of frequency synthesizers may be suitable. For example, synthesizer circuitry 906d may be a delta-sigma synthesizer, a frequency multiplier, or a synthesizer comprising a phase-locked loop with a frequency divider. The synthesizer circuitry 906d may be configured to synthesize an output frequency for use by the mixer circuitry 906a of the RF circuitry 906 based on a frequency input and a divider control input. In some embodiments, the synthesizer circuitry 906d may be a fractional N/N+1 synthesizer.

In some embodiments, frequency input may be provided by a voltage controlled oscillator (VCO), although that is not a requirement. Divider control input may be provided by either the baseband circuitry 904 or the application circuitry 902 depending on the desired output frequency. In some embodiments, a divider control input (e.g., N) may be determined from a look-up table based on a channel indicated by the application circuitry 902.

Synthesizer circuitry 906d of the RF circuitry 906 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 906d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 906 may include an IQ/polar converter.

FEM circuitry 908 may include a receive signal path that may include circuitry configured to operate on RF signals received from one or more antennas 910, amplify the received signals and provide the amplified versions of the received signals to the RF circuitry 906 for further processing. FEM circuitry 908 may also include a transmit signal path that may include circuitry configured to amplify signals for transmission provided by the RF circuitry 906 for transmission by one or more of the one or more antennas 910. In some embodiments, the FEM circuitry 908 may include a TX/RX switch to switch between transmit mode and receive mode operation. The FEM circuitry 908 may include a receive signal path and a transmit signal path. The receive signal path of the FEM circuitry may include a low-noise amplifier (LNA) to amplify received RF signals and provide the amplified received RF signals as an output (e.g., to the RF circuitry 906). The transmit signal path of the FEM circuitry 908 may include a power amplifier (PA) to amplify input RF signals (e.g., provided by RF circuitry 906), and one or more filters to generate RF signals for subsequent transmission (e.g., by one or more of the one or more antennas 910).

In some embodiments, the apparatus 900 may include additional elements such as, for example, a display, a camera, one or more sensors, and/or interface circuitry (for example, input/output (I/O) interfaces or buses) (not shown). In embodiments where the apparatus is implemented in or by an eNB, the apparatus 900 may include network interface circuitry. The network interface circuitry may be one or more computer hardware components that connect apparatus 900 to one or more network elements, such as one or more servers within a core network or one or more other eNBs via a wired connection. To this end, the network interface circuitry may include one or more dedicated processors and/or field programmable gate arrays (FPGAs) to communicate using one or more network communications protocols such as X2 application protocol (AP), S1 AP, Stream Control Transmission Protocol (SCTP), Ethernet, Point-to-Point (PPP), Fiber Distributed Data Interface (FDDI), and/or any other suitable network communications protocols.

In some embodiments, the apparatus of FIG. 9 may be configured to perform one or more processes, techniques, and/or methods as described herein, or portions thereof.

The following paragraphs describe examples of various embodiments.

Example 1 includes an apparatus for a user equipment (UE), which includes baseband circuitry including one or more processors to: encode an uplink (UL) transmission data for transmission to an evolved Node B (eNB) on an unlicensed spectrum; determine a mode of re-transmission for the UL transmission as one of: a scheduled mode in which the re-transmission is based on a re-transmission grant derived from downlink control information (DCI) received from the eNB, and a grant-less mode in which the re-transmission is performed without the re-transmission grant from the eNB; and encode the re-transmission of the UL transmission based on the determined mode.

Example 2 includes the apparatus of Example 1, wherein the baseband circuitry is further configured to: decode a hybrid automatic repeat request (HARQ) feedback received from the eNB; and determine the mode of re-transmission in response to the HARQ feedback indicating a negative acknowledgement (NACK) at the eNB of the UL transmission.

Example 3 includes the apparatus of Example 2, wherein the baseband circuitry is to further: determine the mode of re-transmission as the scheduled mode if a HARQ process number associated with the UL transmission falls outside of a predefined group.

Example 4 includes the apparatus of Example 3, wherein the baseband circuitry is to further: decode dedicated or broadcast radio resource control (RRC) signaling to configure the group.

Example 5 includes the apparatus of Example 2, wherein the HARQ feedback includes a HARQ bitmap indicating acknowledgement (ACK) and NACK at the eNB for a plurality of UL transmissions associated with corresponding HARQ process numbers.

Example 6 includes the apparatus of Example 5, wherein the baseband circuitry is to further: encode another UL transmission data in response to the HARQ feedback indicating an ACK at the eNB of the UL transmission.

Example 7 includes the apparatus of any of Examples 1-6, wherein the baseband circuitry is to further: start a timer upon finishing the UL transmission; and determine the mode of re-transmission as the scheduled mode if the re-transmission grant is derived before expiration of the timer, and as the grant-less mode when the timer expires without the re-transmission grant.

Example 8 includes the apparatus of Example 7, wherein the baseband circuitry is to further: determine the mode of re-transmission as the grant-less mode when the timer expires without receiving a hybrid automatic repeat request (HARQ) feedback from the eNB.

Example 9 includes the apparatus of Example 2, wherein the baseband circuitry is to further: start a timer upon receiving the HARQ feedback; and determine the mode of re-transmission as the scheduled mode if the re-transmission grant is derived before expiration of the timer, and as the grant-less mode when the timer expires without the re-transmission grant.

Example 10 includes the apparatus of Example 9, wherein the timer is shared by a plurality of HARQ processes on the UE.

Example 11 includes the apparatus of Example 9, wherein the timer is associated with a single HARQ process associated with the UL transmission.

Example 12 includes the apparatus of any of Examples 1-11, wherein the DCI is configured to assign to the UE a whole system bandwidth or one of a plurality of orthogonal resources.

Example 13 includes the apparatus of any of Examples 1-12, wherein the baseband circuitry is to further: determine the mode of re-transmission as the scheduled mode if the eNB acquires a channel earlier than the UE, and as the grant-less mode if the UE acquires the channel earlier than the eNB.

Example 14 includes the apparatus of any of Examples 1-13, wherein the baseband circuitry is to further: perform a clear channel assessment (CCA) before transmitting the UL transmission and before the re-transmission.

Example 15 includes the apparatus of any of Examples 1-14, wherein the baseband circuitry is to further: encode the UL transmission data for transmission on physical uplink shared channel (PUSCH).

Example 16 includes the apparatus of any of Examples 1-15, wherein the baseband circuitry is to further: encode the UL transmission data for transmission as a grant-less uplink (GUL) transmission.

Example 17 includes an apparatus for a user equipment (UE), which includes baseband circuitry including one or more processors: transmit an uplink (UL) transmission to an evolved Node B (eNB) on an unlicensed spectrum; start a timer upon finishing the UL transmission; and when the timer expires without receiving a hybrid automatic repeat request (HARQ) feedback from the eNB for the UL transmission, perform one of: transmitting, as a new transmission, a packet same as the UL transmission, and performing a re-transmission for the UL transmission.

Example 18 includes the apparatus of Example 17, wherein the baseband circuitry is to further: reset a HARQ process number associated with the UL transmission.

Example 19 includes the apparatus of Example 18, wherein the baseband circuitry is to further: make a predetermined number of attempts of the new transmission or the re-transmission before resetting the HARQ process number.

Example 20 includes an apparatus of an evolved Node B (eNB), which includes baseband circuitry including one or more processors to: decode uplink (UL) transmission data received from user equipment (UE) on an unlicensed spectrum; and encode a hybrid automatic repeat request (HARQ) feedback for the UE, wherein the HARQ feedback includes a HARQ bitmap indicating acknowledgement (ACK) and negative acknowledgement (NACK) at the eNB for the UL transmissions associated with corresponding HARQ process numbers.

Example 21 includes the apparatus of Example 20, wherein the baseband circuitry is to further: encode downlink control information (DCI) for transmission to the UE to schedule a re-transmission of one or more of the UL transmission indicated as NACK in the HARQ bitmap.

Example 22 includes the apparatus of Example 20 or 21, wherein the baseband circuitry is to further: encode configuration data for the UE to configure the UE with a group of HARQ process numbers through dedicated or broadcast radio resource control (RRC) signaling, wherein if a UL transmission indicated as NACK is associated with a HARQ process number falling within the group, a re-transmission of the UL transmission can be performed without a re-transmission grant from the eNB.

Example 23 includes the apparatus of any of Examples 20-22, wherein the baseband circuitry is to further: encode the HARQ feedback for transmission to the UE during a maximum channel occupancy time (MCOT) of a second UE different from the UE.

Example 24 includes the apparatus of Example 21, wherein the DCI is to be transmitted to the UE during a maximum channel occupancy time (MCOT) of a second UE different from the UE.

Example 25 includes the apparatus of Example 21, wherein the DCI is configured to assign to the UE a whole system bandwidth or one of a plurality of orthogonal resources.

Example 26 includes the apparatus of any of Examples 20-25, wherein the baseband circuitry is to further: encode physical downlink control channel (PDCCH) to include the HARQ feedback.

Example 27 includes the apparatus of any of Examples 20-26, wherein the baseband circuitry is to further: perform a clear channel assessment (CCA) before transmitting the HARQ feedback.

Example 28 includes a method performed at a user equipment (UE), including: encoding an uplink (UL) transmission data for transmission to an evolved Node B (eNB) on an unlicensed spectrum; determining a mode of re-transmission for the UL transmission as one of: a scheduled mode in which the re-transmission is based on a re-transmission grant derived from downlink control information (DCI) received from the eNB, and a grant-less mode in which the re-transmission is performed without the re-transmission grant from the eNB; and encoding the re-transmission of the UL transmission based on the determined mode.

Example 29 includes the method of Example 28, and further includes: decoding a hybrid automatic repeat request (HARQ) feedback received from the eNB; and determining the mode of re-transmission in response to the HARQ feedback indicating a negative acknowledgement (NACK) at the eNB of the UL transmission.

Example 30 includes the method of Example 29, wherein the mode of re-transmission is determined as the scheduled mode if a HARQ process number associated with the UL transmission falls outside of a predefined group.

Example 31 includes the method of Example 30, wherein the group is configured by the eNB through dedicated or broadcast radio resource control (RRC) signaling.

Example 32 includes the method of Example 29, wherein the HARQ feedback includes a HARQ bitmap indicating acknowledgement (ACK) and NACK at the eNB for a plurality of UL transmissions associated with corresponding HARQ process numbers.

Example 33 includes the method of Example 32, and further includes: encoding another UL transmission data in response to the HARQ feedback indicating an ACK at the eNB of the UL transmission.

Example 34 includes the method of any of Examples 28-33, and further includes: starting a timer upon finishing the UL transmission; and determining the mode of re-transmission as the scheduled mode if the re-transmission grant is derived before expiration of the timer, and as the grant-less mode when the timer expires without the re-transmission grant.

Example 35 includes the method of Example 34, and further includes: determining the mode of re-transmission as the grant-less mode when the timer expires without receiving a hybrid automatic repeat request (HARQ) feedback from the eNB.

Example 36 includes the method of Example 29, and further includes: starting a timer upon receiving the HARQ feedback; and determining the mode of re-transmission as the scheduled mode if the re-transmission grant is derived before expiration of the timer, and as the grant-less mode when the timer expires without the re-transmission grant.

Example 37 includes the method of Example 36, wherein the timer is shared by a plurality of HARQ processes on the UE.

Example 38 includes the method of Example 36, wherein the timer is associated with a single HARQ process associated with the UL transmission.

Example 39 includes the method of any of Examples 28-38, wherein the DCI is configured to assign to the UE a whole system bandwidth or one of a plurality of orthogonal resources.

Example 40 includes the method of any of Examples 28-39, wherein the mode of re-transmission is determined as the scheduled mode if the eNB acquires a channel earlier than the UE, and as the grant-less mode if the UE acquires the channel earlier than the eNB.

Example 41 includes the method of any of Examples 28-40, and further includes: performing a clear channel assessment (CCA) before transmitting the UL transmission and before the re-transmission.

Example 42 includes the method of any of Examples 28-41, and further includes: encoding the UL transmission data for transmission on physical uplink shared channel (PUSCH).

Example 43 includes the method of any of Examples 28-42, and further includes: encoding the UL transmission data for transmission as a grant-less uplink (GUL) transmission.

Example 44 includes a method performed at a user equipment (UE), including: transmitting an uplink (UL) transmission to an evolved Node B (eNB) on an unlicensed spectrum; starting a timer upon finishing the UL transmission; and when the timer expires without receiving a hybrid automatic repeat request (HARQ) feedback from the eNB for the UL transmission, performing one of: transmitting, as a new transmission, a packet same as the UL transmission, and performing a re-transmission for the UL transmission.

Example 45 includes the method of Example 44, and further includes: resetting a HARQ process number associated with the UL transmission.

Example 46 includes the method of Example 45, and further includes: making a predetermined number of attempts of the new transmission or the re-transmission before resetting the HARQ process number.

Example 47 includes a method performed at an evolved Node B (eNB), including: decoding uplink (UL) transmission data received from user equipment (UE) on an unlicensed spectrum; and encoding a hybrid automatic repeat request (HARQ) feedback for the UE, wherein the HARQ feedback includes a HARQ bitmap indicating acknowledgement (ACK) and negative acknowledgement (NACK) at the eNB for the UL transmissions associated with corresponding HARQ process numbers.

Example 48 includes the method of Example 47, and further includes: encoding downlink control information (DCI) for transmission to the UE to schedule a re-transmission of one or more of the UL transmission indicated as NACK in the HARQ bitmap.

Example 49 includes the method of Example 47 or 48, and further includes: encoding configuration data for the UE to configure the UE with a group of HARQ process numbers through dedicated or broadcast radio resource control (RRC) signaling, wherein if a UL transmission indicated as NACK is associated with a HARQ process number falling within the group, a re-transmission of the UL transmission can be performed without a re-transmission grant from the eNB.

Example 50 includes the method of any of Examples 47-50, and further includes encoding the HARQ feedback for transmission to the UE during a maximum channel occupancy time (MCOT) of a second UE different from the UE.

Example 51 includes the method of Example 48, wherein the DCI is to be transmitted to the UE during a maximum channel occupancy time (MCOT) of a second UE different from the UE.

Example 52 includes the method of Example 48, wherein the DCI is configured to assign to the UE a whole system bandwidth or one of a plurality of orthogonal resources.

Example 53 includes the method of any of Examples 47-52, and further includes encoding physical downlink control channel (PDCCH) to include the HARQ feedback.

Example 54 includes the method of any of Examples 47-53, and further includes performing a clear channel assessment (CCA) before transmitting the HARQ feedback.

Example 55 includes a non-transitory computer-readable medium having instructions stored thereon, the instructions when executed by one or more processor(s) causing the processor(s) to perform the method of any of Examples 28-54.

Example 56 includes an apparatus for user equipment (UE), including means for performing the actions of the method of any of Examples 28-46.

Example 57 includes an apparatus for an evolved Node B (eNB), including means for performing the actions of the method of any of Examples 47-54.

Example 58 includes User equipment (UE) as shown and described in the description.

Example 59 includes an evolved Node B (eNB) as shown and described in the description.

Example 60 includes a method performed at user equipment (UE) as shown and described in the description.

Example 61 includes a method performed at an evolved Node B (eNB) as shown and described in the description.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1.-25. (canceled)

26. An apparatus for a user equipment (UE), comprising:
baseband circuitry including one or more processors to:
encode an uplink (UL) transmission data for transmission to an evolved Node B (eNB) on an unlicensed spectrum;
determine a mode of re-transmission for the UL transmission as one of: a scheduled mode in which the re-transmission is based on a re-transmission grant derived from downlink control information (DCI) received from the eNB, and a grant-less mode in which the re-transmission is performed without the re-transmission grant from the eNB; and
encode the re-transmission of the UL transmission based on the determined mode.

27. The apparatus of claim 26, wherein the baseband circuitry is further configured to:
decode a hybrid automatic repeat request (HARQ) feedback received from the eNB; and
determine the mode of re-transmission in response to the HARQ feedback indicating a negative acknowledgement (NACK) at the eNB of the UL transmission.

28. The apparatus of claim 27, wherein the baseband circuitry is to further:
determine the mode of re-transmission as the scheduled mode if a HARQ process number associated with the UL transmission falls outside of a predefined group.

29. The apparatus of claim 28, wherein baseband circuitry is to further:
decode dedicated or broadcast radio resource control (RRC) signaling to configure the group.

30. The apparatus of claim 27, wherein the HARQ feedback comprises a HARQ bitmap indicating acknowledgement (ACK) and NACK at the eNB for a plurality of UL transmissions associated with corresponding HARQ process numbers.

31. The apparatus of claim 30, wherein the baseband circuitry is to further:
encode another UL transmission data in response to the HARQ feedback indicating an ACK at the eNB of the UL transmission.

32. The apparatus of claim 26, wherein the baseband circuitry is to further:
start a timer upon finishing the UL transmission; and
determine the mode of re-transmission as the scheduled mode if the re-transmission grant is derived before expiration of the timer, and as the grant-less mode when the timer expires without the re-transmission grant.

33. The apparatus of claim 32, wherein the baseband circuitry is to further determine the mode of re-transmission as the grant-less mode when the timer expires without receiving a hybrid automatic repeat request (HARQ) feedback from the eNB.

34. The apparatus of claim 27, wherein the baseband circuitry is to further:
start a timer upon receiving the HARQ feedback; and
determine the mode of re-transmission as the scheduled mode if the re-transmission grant is derived before expiration of the timer, and as the grant-less mode when the timer expires without the re-transmission grant.

35. The apparatus of claim 34, wherein the timer is shared by a plurality of HARQ processes on the UE.

36. The apparatus of claim 34, wherein the timer is associated with a single HARQ process associated with the UL transmission.

37. The apparatus of claim 26, wherein the DCI is configured to assign to the UE a whole system bandwidth or one of a plurality of orthogonal resources.

38. The apparatus of claim 26, wherein the baseband circuitry is to further:
determine the mode of re-transmission as the scheduled mode if the eNB acquires a channel earlier than the UE, and as the grant-less mode if the UE acquires the channel earlier than the eNB.

39. The apparatus of claim 26, wherein the baseband circuitry is to further:
perform a clear channel assessment (CCA) before transmitting the UL transmission and before the re-transmission.

40. The apparatus of claim 26, wherein the baseband circuitry is to further:
encode the UL transmission data for transmission on physical uplink shared channel (PUSCH).

41. The apparatus of claim 26, wherein the baseband circuitry is to further:
encode the UL transmission data for transmission as a grant-less uplink (GUL) transmission.

42. An apparatus for a user equipment (UE), comprising:
baseband circuitry including one or more processors to:
encode an uplink (UL) transmission to an evolved Node B (eNB) on an unlicensed spectrum;
start a timer upon finishing the UL transmission; and
when the timer expires without receiving a hybrid automatic repeat request (HARD) feedback from the eNB for the UL transmission, perform one of:
transmitting, as a new transmission, a packet same as the UL transmission, and
performing a re-transmission for the UL transmission.

43. The apparatus of claim 42, wherein the baseband circuitry is to further:
reset a HARQ process number associated with the UL transmission.

44. The apparatus of claim 43, wherein the baseband circuitry is to further:
make a predetermined number of attempts of the new transmission or the re-transmission before resetting the HARQ process number.

45. An apparatus of an evolved Node B (eNB), comprising:
baseband circuitry, including one or more processors, to:
decode uplink (UL) transmission data received from user equipment (UE) on an unlicensed spectrum; and
encode a hybrid automatic repeat request (HARQ) feedback for the UE, wherein the HARQ feedback comprises a HARQ bitmap indicating acknowledgement (ACK) and negative acknowledgement (NACK) at the eNB for the UL transmissions associated with corresponding HARQ process numbers.

46. The apparatus of claim 45, wherein the baseband circuitry is to further:
encode downlink control information (DCI) for transmission to the UE to schedule a re-transmission of one or more of the UL transmission indicated as NACK in the HARQ bitmap.

47. The apparatus of claim 45, wherein the baseband circuitry is to further:
encode configuration data for the UE to configure the UE with a group of HARQ process numbers through dedicated or broadcast radio resource control (RRC) signaling, wherein if a UL transmission indicated as NACK is associated with a HARQ process number falling within the group, a re-transmission of the UL transmission can be performed without a re-transmission grant from the eNB.

48. The apparatus of claim 45, wherein the baseband circuitry is to further:
encode the HARQ feedback for transmission to the UE during a maximum channel occupancy time (MCOT) of a second UE different from the UE.

49. The apparatus of claim 46, wherein the DCI is to be transmitted to the UE during a maximum channel occupancy time (MCOT) of a second UE different from the UE.

50. The apparatus of claim 46, wherein the DCI is configured to assign to the UE a whole system bandwidth or one of a plurality of orthogonal resources.
